(19) United States
(12) Patent Application Publication
(10) Pub. No.: US 2019/0337227 A1
(43) Pub. Date: Nov. 7, 2019

(54) LAMINATING AND SHAPING APPARATUS AND METHOD FOR CONTROLLING LAMINATING AND SHAPING APPARATUS

(71) Applicant: KANTATSU CO., LTD., Yaita-shi (JP)

(72) Inventor: Eiji OSHIMA, Tochigi (JP)

(21) Appl. No.: 16/386,080

(22) Filed: Apr. 16, 2019

(30) Foreign Application Priority Data
May 2, 2018 (JP) 2018-088860

(51) Int. Cl. B29C 64/255; B29C 64/165; B29C 64/135; B29C 64/153; B33Y 10/00; B33Y 30/00

(52) U.S. Cl. CPC B29C 64/255; B29C 64/165; B33Y 30/00; B29C 64/153; B33Y 10/00; B29C 64/135

(57) ABSTRACT

This invention enables to shape a laminated and shaped product by lamination in a horizontal direction and provide a laminating and shaping apparatus including a shaping tank in which a laminated and shaped product is shaped by an accommodated shaping material, a slider that has a shaping reference surface as a base of the laminated and shaped product, and slidably moves in a direction away from an inner wall of the shaping tank and perpendicular to the shaping reference surface, a light emitter that emits a light beam to the shaping material in the shaping tank from outside the shaping tank, and a material supplier that supplies the shaping material between an inner wall of the shaping tank, which is formed on a side of the light emitter, and the shaping reference surface, by dropping the shaping material. The light emitter emits the light beam to the shaping material accommodated between the inner wall and the shaping reference surface.

### CROSS-REFERENCE TO RELATED APPLICATION

This application is based upon and claims the benefit of priority from Japanese patent application No. 2018-088860, filed on May 2, 2018, the disclosure of which is incorporated herein in its entirety by reference.

### BACKGROUND OF THE INVENTION

### Field of the Invention

The present invention relates to a laminating and shaping apparatus and a method for controlling the laminating and shaping apparatus.

### Description of the Related Art

In the above technical field, patent literature 1 discloses a technique of performing lamination and shaping in the vertical direction.

[Patent Literature 1] Japanese Patent Laid-Open No. 2017-203199

### SUMMARY OF THE INVENTION

In the technique described in the above literature, however, a laminated and shaped product cannot be shaped by lamination in the horizontal direction.

The present invention enables to provide a technique of solving the above-described problem.

One example aspect of the present invention provides a laminating and shaping apparatus including

a shaping tank in which a laminated and shaped product is shaped by an accommodated shaping material,

a slider that has a shaping reference surface as a base of the laminated and shaped product, and slidably moves in a direction away from an inner wall of the shaping tank and perpendicular to the shaping reference surface,

a light emitter that emits a light beam to the shaping material in the shaping tank from outside the shaping tank, and

a material supplier that supplies the shaping material between an inner wall of the shaping tank, which is formed on a side of the light emitter, and the shaping reference surface, by dropping the shaping material,

wherein the light emitter emits the light beam to the shaping material accommodated between the inner wall and the shaping reference surface.

Another example aspect of the present invention provides a method for controlling a laminating and shaping apparatus including

a shaping tank in which a laminated and shaped product is shaped by an accommodated shaping material, and

a slider that has a shaping reference surface as a base of the laminated and shaped product, and slidably moves in a direction away from an inner wall of the shaping tank and perpendicular to the shaping reference surface,

the method comprising

supplying the shaping material between an inner wall of the shaping tank, which is formed on a side of the light emitter, and the shaping reference surface, by dropping the shaping material, and

emitting a light beam to the shaping material in the shaping tank from outside the shaping tank,

wherein in the emitting, the light beam is emitted to the shaping material accommodated between the inner wall and the shaping reference surface.

According to the present invention, a laminated and shaped product can be shaped by lamination in the horizontal direction.

### BRIEF DESCRIPTION OF THE DRAWINGS

FIG. 1 is a block diagram showing the arrangement of a laminating and shaping apparatus according to the first example embodiment of the present invention;

FIG. 2A is a perspective view for explaining a laminating and shaping apparatus according to the second example embodiment of the present invention;

FIG. 2B is a front view for explaining the laminating and shaping apparatus according to the second example embodiment of the present invention;

FIG. 2C is a perspective view for explaining an example of a shaping tank of the laminating and shaping apparatus according to the second example embodiment of the present invention;

FIG. 2D is a perspective view for explaining an example of the shape of a shaping plate of the laminating and shaping apparatus according to the second example embodiment of the present invention;

FIG. 2E is a perspective view for explaining another example of the shape of the shaping plate of the laminating and shaping apparatus according to the second example embodiment of the present invention;

FIG. 2F is a side view for explaining a light irradiation area in the laminating and shaping apparatus according to the second example embodiment of the present invention;

FIG. 3 is a flowchart for explaining the procedure of the laminating and shaping apparatus according to the second example embodiment of the present invention;

FIG. 4A is a schematic front view for explaining a laminating and shaping apparatus according to the third example embodiment of the present invention; and

FIG. 4B is a schematic front view for explaining the laminating and shaping apparatus according to the third example embodiment of the present invention.

### DESCRIPTION OF THE EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

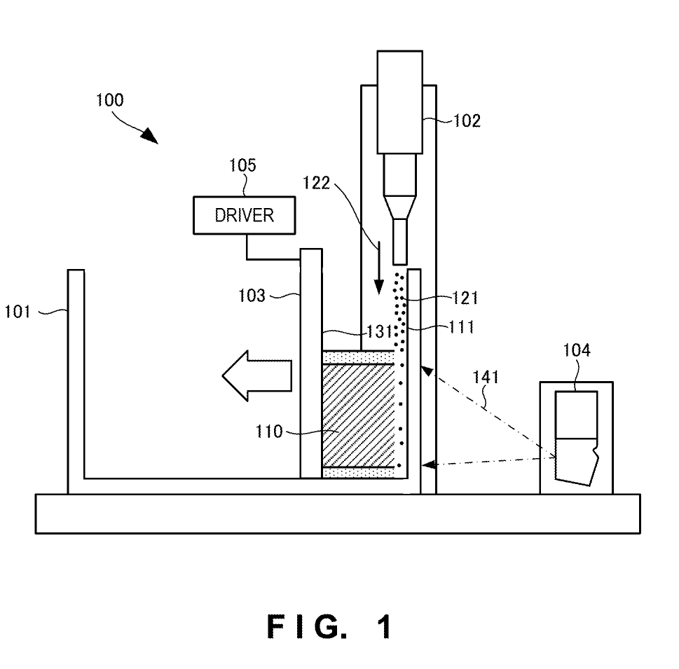

A laminating and shaping apparatus 100 according to the first example embodiment of the present invention will be explained with reference to FIG. 1. The laminating and shaping apparatus 100 is an apparatus for manufacturing a laminated and shaped product.

As shown in FIG. 1, the laminating and shaping apparatus 100 includes a shaping tank 101, a material supplier 102, a slider 103, and a light emitter 104.

In the shaping tank 101, a laminated and shaped product 110 is shaped by a shaping material 121 accommodated in the shaping tank 101. The slider 103 has a shaping reference surface 131 as a base of the laminated and shaped product 110, and slidably moves in a direction away from an inner wall 111 of the shaping tank 101 and perpendicular to the shaping reference surface 131. The light emitter 104 emits a light beam 141 to the shaping material 121 in the shaping tank 101 from outside the shaping tank 101. The material supplier 102 supplies the shaping material 121 by dropping it between the inner wall 111 of the shaping tank 101, which is positioned on the side of the light emitter 104, and the shaping reference surface 131. The light emitter 104 emits the light beam 141 to the shaping material 121 accommodated between the inner wall 111 and the shaping reference surface 131.

According to this example embodiment, a laminated and shaped product can be shaped by lamination in the horizontal direction.

### Second Example Embodiment

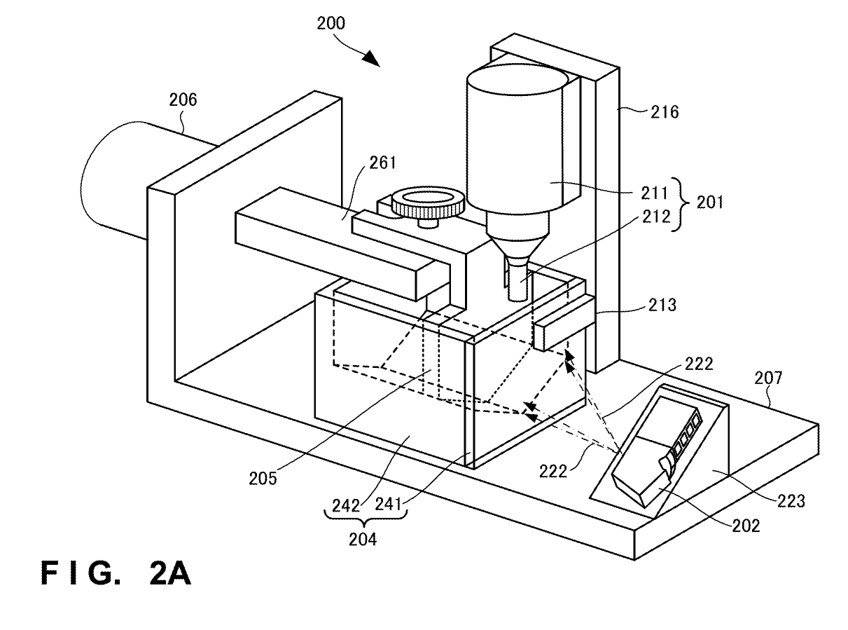

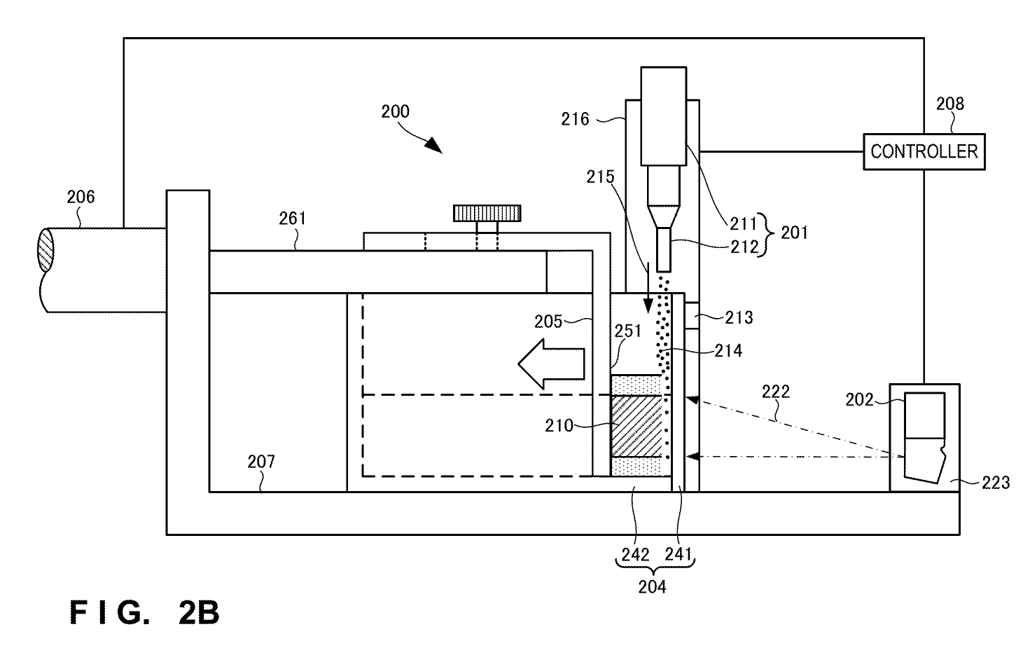

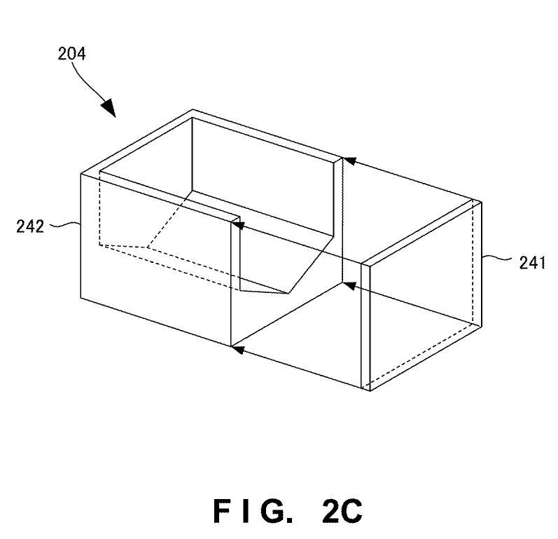

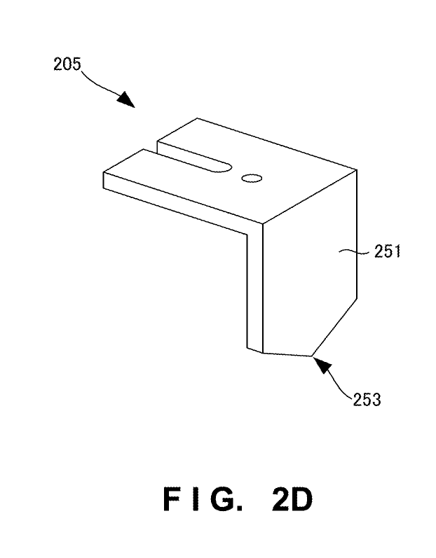

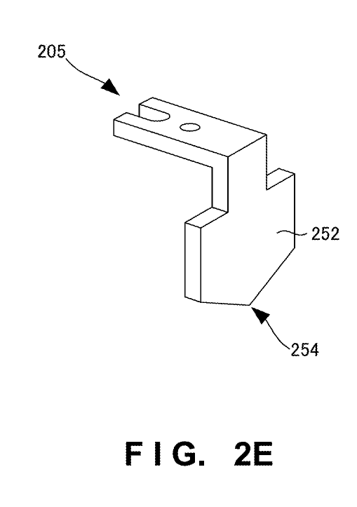

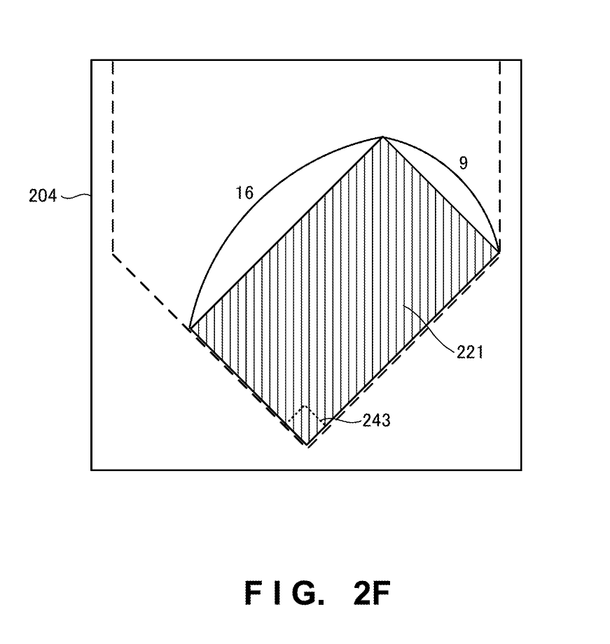

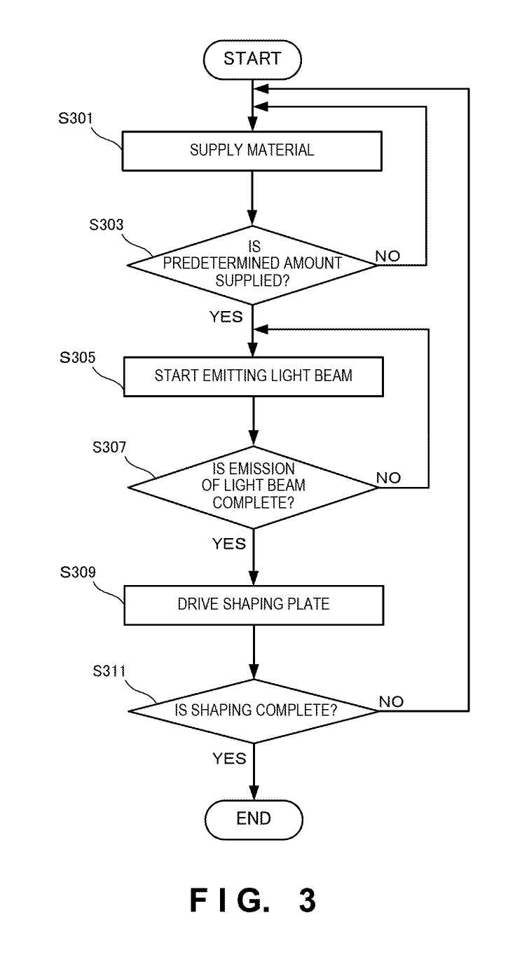

A laminating and shaping apparatus according to the second example embodiment of the present invention will be explained below with reference to FIGS. 2A to 3. FIG. 2A is a perspective view for explaining the laminating and shaping apparatus according to this example embodiment. FIG. 2B is a front view for explaining the laminating and shaping apparatus according to this example embodiment.

A laminating and shaping apparatus 200 includes a material supplier 201, a light emitter 202, a shaping tank 204, a shaping plate 205 (a slider), a driver 206, a base plate 207, and a controller 208.

The material supplier 201 supplies a shaping material 214 of a laminated and shaped product 210 to the shaping tank 204 (into the shaping tank) by dropping the shaping material 214, and is also called a dispenser. The material supplier 201 includes a material storage 211 and a nozzle 212. The material storage 211 temporarily stores the shaping material 214 of the laminated and shaped product 210, and is called a hopper or the like. The shaping material 214 stored in the material storage 211 is a powder material or a liquid material, but is not limited to these materials, and may also be a resin material or the like. The shaping material 214 stored in the material storage 211 is supplied from the nozzle 212 at the distal end of the material supplier 201. For example, the shaping material 214 supplied from the material supplier 201, that is, the shaping material 214 released from the nozzle 212 reaches the shaping tank 204 by free fall (gravity) after leaving the nozzle 212. That is, the material supplier 201 supplies the shaping material 214 into the shaping tank 204 by dropping the shaping material 214. Note that the shaping material 214 supplied from the material supplier 201 can also be released by being pushed by an air pressure or the like. The material supplier 201 thus recoats the shaping material 214.

A supply amount sensor 213 (a detector) detects the supply amount of the shaping material 214 supplied into the shaping tank 204. For example, the supply amount sensor 213 is an ultrasonic sensor or an infrared sensor. For example, when the shaping material 214 supplied into the shaping tank 204 by falling reaches a position (height) at which the supply amount sensor 213 is attached, the supply amount sensor 213 detects the shaping material 214, so the supply amount of the shaping material 214 can be detected. It is also possible to detect the supply amount of the shaping material 214 based on, for example, a time during which the shaping material 214 traverses the supply amount sensor 213. However, the supply amount detection method is not limited to this.

The supply amount sensor 213 transmits the detected supply amount data to the material supplier 201 and the like. The material supplier 201 can adjust the supply amount of the shaping material 214 based on the received material supply amount data.

The light emitter 202 emits, from outside the shaping tank 204, a light beam 222 to the shaping material 214 supplied from the material supplier 201 and accommodated in the shaping tank 204. The light emitter 202 is placed on a base 223. The light emitter 202 includes an optical engine. This optical engine is a high-output, high-resolution engine. Note that the light beam 222 to be emitted from the optical engine has a wavelength of 405 nm, but the wavelength is not limited to this and may also be 200 to 400 nm. Note also that the light beam 222 to be emitted from the optical engine is focus-free, but need not be focus-free.

Although a detailed arrangement of the optical engine is not illustrated, the optical engine includes a light source, a reflecting mirror, a photodetector, and a two-dimensional MEMS (Micro Electro Mechanical Systems) mirror. The light source includes a semiconductor LD (Laser Diode) and a collimator lens. The semiconductor LD is a laser oscillation element that oscillates a UV laser beam or the like. Note that the laser oscillation element is not limited to the semiconductor LD, and may also be an LED (Light Emitting Diode). The two-dimensional MEMS mirror is a driving mirror that is driven based on a control signal input from the outside. The two-dimensional MEMS mirror is a device that so vibrates as to reflect the laser beam while changing the angle in the horizontal direction (X direction) and the vertical direction (Y direction). The optical engine has a resolution of 720 P or 1,080 P, and has a width of about 30 mm, a depth of about 15 mm, a height of about 7 mm, and a volume of about 3 cc. One or a plurality of semiconductor LDs can be arranged in the optical engine, that is, a necessary number of optical engines can be arranged in accordance with the application purpose. The spot size of the light beam 222 emitted from the optical engine is 75 μm, but can be changed in accordance with the application purpose. Note that the mirror system used for the optical engine may also be, for example, a galvanometer mirror system or a DLP (Digital Light Processing) system, instead of the two-dimensional MEMS mirror system.

The shaping tank 204 is a rectangular parallelepiped (box-like) tank in which the laminated and shaped product 210 is shaped. The upper portion (upper surface) of the shaping tank 204, that is, the surface facing the material supplier 201 is open. The shaping tank 204 is arranged in the position of (below) the lower portion of the material supplier 201. The shaping material 214 supplied from the material supplier 201 reaches the shaping tank 204 through the upper opening of the shaping tank 204. Note that the shape of the shaping tank 204 is not limited to a rectangular parallelepiped shape and may also be a cubic shape or another shape.

The shaping tank 204 includes a tank cover 241 and a tank case 242. The tank cover 241 is a side portion (wall portion) on the right side (the right side in FIGS. 2A and 2B) of the shaping tank 204. The tank cover 241 is a member (light transmitting member) such as glass, plastic, or a resin which transmits the light beam 222. However, the member is not limited to these materials as long as the member can transmit the light beam 222.

In addition, the supply amount sensor 213 for detecting the supply amount of the shaping material 214 from the material supplier 201 is arranged on the outer side surface (the surface or outer wall on the side of the light emitter 202) of the tank cover 241. The supply amount sensor 213 is arranged near the distal end of the nozzle 212 of the material supplier 201.

Inside the shaping tank 204, the bottom-surface side (lower side) has a V-shape (valley-like shape) (the angle of V is 90°). However, the shape of the bottom surface of the shaping tank 204 is not limited to this, and may also be a planar shape (flat shape).

The shaping plate 205 (a slider) is a platform on which the laminated and shaped product 210 is shaped. The shaping plate 205 has a shaping reference surface 251 as the base of the laminated and shaped product 210. That is, the laminated and shaped product 210 is shaped on the shaping reference surface 251 of the shaping plate 205. The shaping plate 205 is installed such that the shaping reference surface 251 is parallel to a falling direction 215 of the shaping material 214 or the vertical direction. That is, the shaping reference surface 251 is a surface parallel to the vertical direction. Therefore, the laminated and shaped product 210 to be shaped on the shaping reference surface 251 is laminated in a direction (horizontal direction) perpendicular to the vertical direction. Note that the shaping reference surface 251 is not limited to the surface parallel to the vertical direction, and may also be a surface which makes an angle of 45° or less with respect to the vertical direction. The shaping material 214 of the laminated and shaped product 210 is supplied to the gap between the shaping plate 205 and the tank cover 241 on the side of the shaping tank 204, on which the light emitter 202 is installed. That is, the material supplier 201 supplies the shaping material 214 to the gap between the inner wall of the shaping tank 204 on the side of the light emitter 202 (the inner wall of the tank cover 241) and the shaping reference surface 251 of the shaping plate 205. The amount of the shaping material 214 to be supplied from the material supplier 201 can also be adjusted by, for example, the distance between the tank cover 241 and the shaping plate 205. Also, the thickness of one layer of the laminated and shaped product 210 can be determined by the distance between the tank cover 241 and the shaping plate 205. The thickness (lamination pitch) of one layer of the laminated and shaped product 210 is, for example, 0.05 to 0.1 mm, but is not limited to this value.

Then, the light emitter 202 emits the light beam 222 to the shaping material 214 of one layer, which is supplied between the tank cover 241 (the inner wall of the shaping tank 204) and the shaping reference surface 251 and accommodated between them. The shaping material 214 irradiated with the light beam 222 solidifies, and the shaping material 214 not irradiated with the light beam 222 does not solidify. When the supply and solidification of the shaping material of one layer are complete, the laminating and shaping apparatus 200 performs the supply and solidification of the shaping material 214 of the next one layer. The laminating and shaping apparatus 200 shapes the laminated and shaped product 210 by repeating this process.

Also, the shaping plate 205 has an inverted V-shape (mountain-like shape) matching the V-shape of the bottom surface of the shaping tank 204. The laminated and shaped product 210 is shaped on the surface (the shaping reference surface 251) of the shaping plate 205 on the side of the tank cover 241.

The driver 206 includes a linear driver unit 261 extended from the driver 206. The shaping plate 205 is connected to the linear driver unit 261. The driver 206 is a driving mechanism such as an actuator or a motor, and the linear driver unit 261 moves when the driver 206 is driven. In synchronism with the movement of the linear driver unit 261, the shaping plate 205 connected to the linear driver unit 261 also slidably moves in the direction perpendicular to the shaping reference surface 251. The distance between the tank cover 241 and the shaping plate 205 is adjusted by driving the driver 206.

The light emitter 202, the shaping tank 204, and the like are placed on the base plate 207. That is, the light emitter 202, the shaping tank 204, and the like are installed on the base plate 207. Note that the material supplier 201 is attached to the base plate 207 by using an installation plate 216. The light emitter 202 is placed on the placement surface of the base 223 installed on the upper surface of the base plate 207. The placement surface of the base 223 has a predetermined inclination angle with respect to the base plate 207. The light emitter 202 placed on the base 223 is inclined at a predetermined angle with respect to the base plate 207. The inclination angle of the placement surface of the base 223 can be either constant or freely changeable. Note that the falling direction 215 of the shaping material 214 is a direction perpendicular to the base plate 207.

On the base plate 207, the light emitter 202 is so installed as to emit the light beam 222 in the horizontal direction to the shaping tank 204, that is, in the direction perpendicular to the vertical direction (the falling direction 215 in which the shaping material 214 falls from the material supplier 201). Also, the material supplier 201 is installed such that the shaping material 214 can be supplied from above the shaping tank 204.

The shaping tank 204 is thus arranged in the horizontal direction (the direction horizontal to the placement surface of the base plate 207) of the light emitter 202. Accordingly, the laminating and shaping apparatus 200 can manufacture the laminated and shaped product 210 by lamination in the horizontal direction.

The controller 208 receives the supply amount data detected by the supply amount sensor 213. In accordance with the detection result obtained by the supply amount sensor 213, the controller 208 controls the material supplier 201, the light emitter 202, the driver 206, and the like. That is, the controller 208 controls the supply amount and supply timing of the shaping material 214 to be supplied by the material supplier 201. The controller 208 also controls the emission intensity and emission time of the light beam 222 to be emitted by the light emitter 202. Furthermore, the controller 208 controls the moving amount and moving timing of the shaping plate 205 which is moved by the driver 206.

FIG. 2C is a perspective view for explaining an example of the shaping tank of the laminating and shaping apparatus according to this example embodiment. The shaping tank 204 includes the tank cover 241 and the tank case 242. The shaping tank 204 is formed by attaching the tank cover 241 to the tank case 242. The shaping tank 204 has a rectangular parallelepiped shape, and has the upper opening. That is, the shaping tank 204 is a rectangular parallelepiped (box) having no upper lid.

The tank cover 241 is a plate member equivalent to one of the four side surfaces (four walls) of the rectangular parallelepiped shaping tank 204. The tank cover 241 is attached to the tank case 242 by a method such as screwing or adhesion using an adhesive. The tank cover 241 can also detachably be attached to the tank case 242. Note that the method of attaching the tank cover 241 is not limited to these methods.

When viewed in the attaching direction of the tank cover 241, the bottom surface of the tank case 242 has a (90°) V-shape (valley-like shape) having a recessed central portion. The angle of the V-shape is not limited to 90°. Note that the shape of the bottom surface of the tank case 242 may also be a flat shape. When the shape of the bottom surface of the tank case 242 is a planar shape, the light emitter 202 is installed parallel to the upper surface of the base plate 207. Consequently, the light emitter 202 and the bottom surface of the tank case 242 are arranged on the same plane.

The tank cover 241 is a member made of glass, plastic, a resin, or the like, and an example is a transparent member. Note that the tank cover 241 can be either a partly transparent member or an entirely transparent member. Note also that the tank cover 241 can be a member made of any material as long as the material transmits the light beam 222. The tank case 242 is a member made of, for example, a metal, plastic, or a resin, but is not limited to these materials.

FIG. 2D is a perspective view for explaining an example of the shape of the shaping plate of the laminating and shaping apparatus according to this example embodiment. FIG. 2E is a perspective view for explaining another example of the shape of the shaping plate of the laminating and shaping apparatus according to this example embodiment.

Each of the shaping reference surface 251 and a shaping reference surface 252 of the shaping plates 205 has the shape of a home plate of baseball. That is, the shaping reference surfaces 251 and 252 each have a shape corresponding to the shape (V-shape) of the bottom surface of the tank case 242. Therefore, a distal end portion 253 (a portion opposite to the bottom surface of the tank case 242) of the shaping reference surface 251 has a pointed shape. Similarly, a distal end portion 254 (a portion opposite to the bottom surface of the tank case 242) of the shaping reference surface 252 has a pointed shape.

As described above, each of the shaping reference surfaces 251 and 252 is given the shape matching the bottom-surface shape of the tank case 242, so that the shaping material 214 does not leak into the tank case 242 from the shaping plate 205. Although details of the structures are not shown, an arbitrary shape and an arbitrary structure can be used as long as there is no leak. For example, when the bottom-surface shape of the tank case 242 is a flat shape, the distal end portions 253 and 254 of the shaping reference surfaces 251 and 252 also have a flat shape. The shaping plate 205 is connected to the linear driver unit 261 of the driver 206. Accordingly, the shaping plate 205 slidably moves in synchronism with the movement of the linear driver unit 261, so each of the shaping reference surfaces 251 and 252 also slidably moves in synchronism with the movement of the shaping plate 205.

FIG. 2F is a side view for explaining a light irradiation area in the laminating and shaping apparatus according to this example embodiment. That is, FIG. 2F is a schematic view in which the shaping tank 204 is viewed from the light emitter 202. An irradiation area 221 of the light beam 222 emitted from the light emitter 202 is a hatched portion in FIG. 2F. The aspect ratio of this hatched portion is 16:9, but is not limited to this. As shown in FIG. 2F, an angle 243 of the V-shape of the bottom surface of the tank case 242 is 90°. Therefore, the light emitter 202 is inclined at 45° with respect to the base 207 in accordance with this angle. The material supplier 201 supplies (injects) the shaping material 214 from the central portion of the shaping tank 204. Accordingly, to equalize the densities of the shaping material 214 in the two corners of the shaping tank 204, a V-shape is suitable as the bottom-surface shape of the shaping tank 204. Since the inclination angle of the base 223 on which the light emitter 202 is placed is matched with the angle of the V-shape, the light emitter 202 and the bottom surface (one surface of the V-shape) of the tank case 242 are arranged on the same plane.

FIG. 3 is a flowchart for explaining the procedure of the laminating and shaping apparatus according to this example embodiment. A CPU (Central Processing Unit) (not shown) executes this flowchart by using a RAM (Random Access Memory) (not shown), thereby implementing the functional constituent parts of the laminating and shaping apparatus 200 shown in FIGS. 2A to 2E.

In step S301, the laminating and shaping apparatus 200 supplies the shaping material 214 into the shaping tank 204. In step S303, the laminating and shaping apparatus 200 determines whether a predetermined amount of the shaping material 214 is supplied, based on a signal from the supply amount sensor 213. If it is determined that the predetermined amount of the shaping material 214 is not supplied (NO in step S303), the laminating and shaping apparatus 200 returns to step S301 and continues the supply of the shaping material 214. If it is determined that the predetermined amount of the shaping material 214 is supplied (YES in step S303), the laminating and shaping apparatus 200 stops the supply of the shaping material 214 and advances to step S305.

In step S305, the laminating and shaping apparatus 200 starts emitting the light beam 222. In step S307, the laminating and shaping apparatus 200 determines whether the emission of the light beam 222 is complete, based on the shaping conditions of a laminated and shaped product. If it is determined that the emission of the light beam 222 is not complete (NO in step S307), the laminating and shaping apparatus 200 returns to step S305 and continues the emission of the light beam 222. If it is determined that the emission of the light beam 222 is complete (YES in step S307), the laminating and shaping apparatus 200 terminates the emission of the light beam 222 and advances to step S309.

In step S309, the laminating and shaping apparatus 200 moves the shaping plate 205 in the direction perpendicular to the falling direction of the shaping material 214. In step S311, the laminating and shaping apparatus 200 determines whether the shaping of the laminated and shaped product is complete. If it is determined that the shaping of the laminated and shaped product is not complete (NO in step S311), the laminating and shaping apparatus 200 returns to step S301 and continues the shaping of the laminated and shaped product 210. If it is determined that the shaping of the laminated and shaped product 210 is complete (YES in step S311), the laminating and shaping apparatus 200 terminates the process.

According to this example embodiment, a laminated and shaped product can be manufactured while laminating the shaping material in the horizontal direction (left-and-right direction). In addition, it is unnecessary to squeegee the shaping material supplied by being dropped from the material supplier (dispenser). This saves trouble for maintenance of the apparatus, reduces failures of the apparatus, and enables rapid shaping of a laminated and shaped product.

### Third Example Embodiment

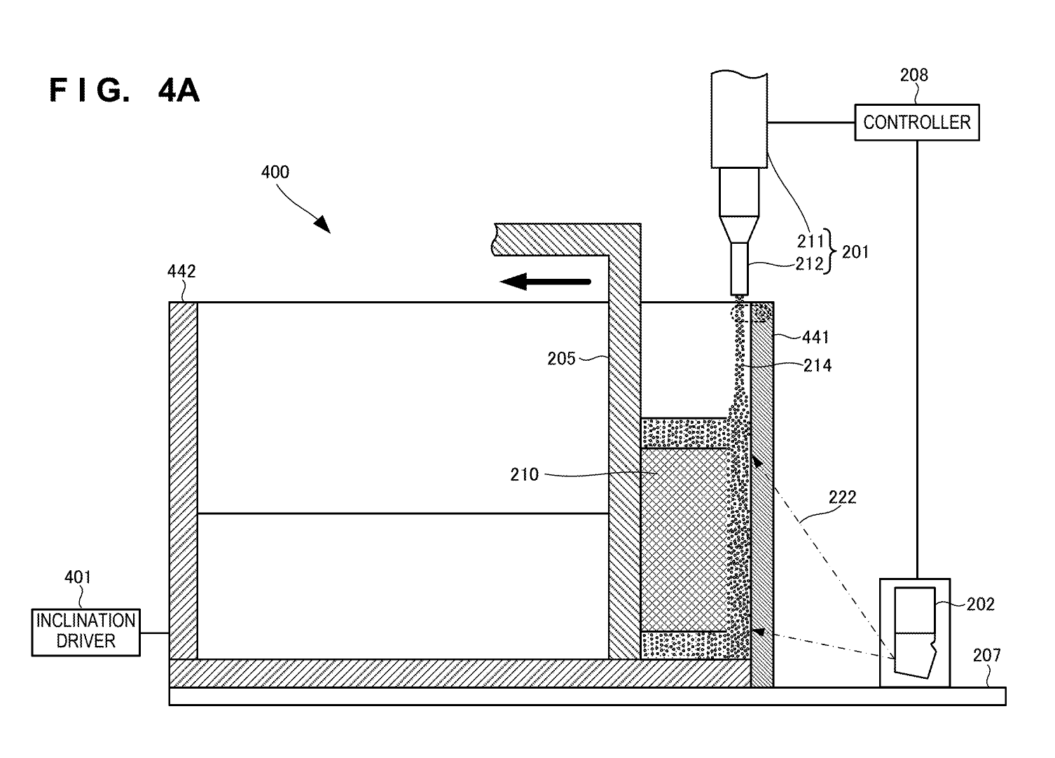

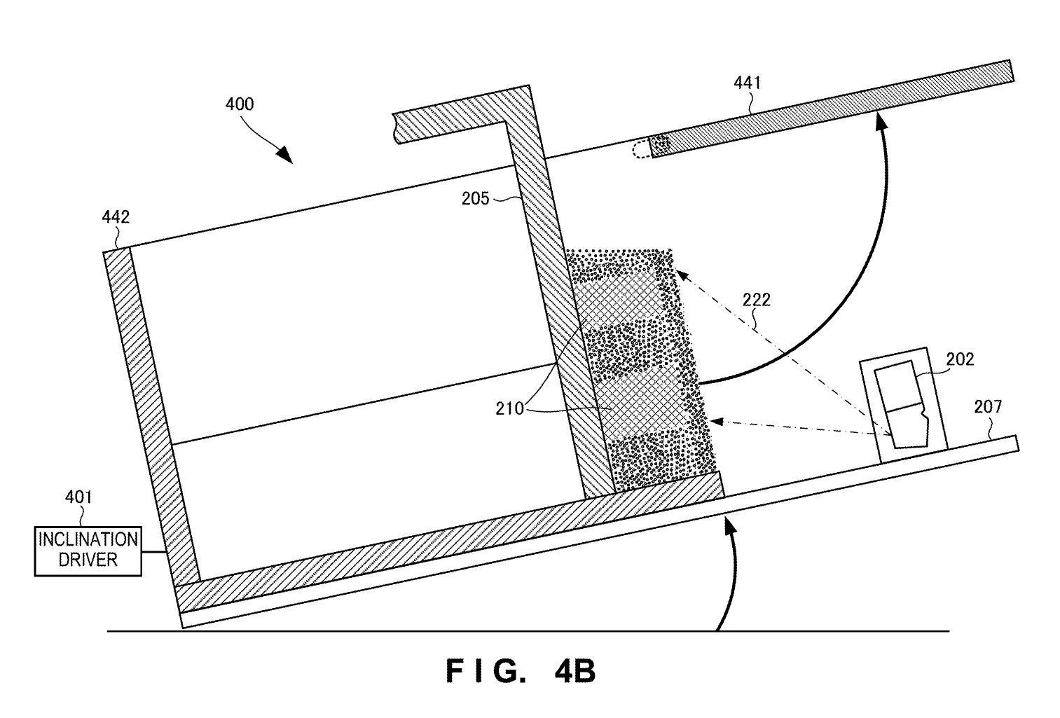

A laminating and shaping apparatus according to the third example embodiment of the present invention will be explained below with reference to FIGS. 4A and 4B. FIG. 4A is a schematic front view for explaining the arrangement of a laminating and shaping apparatus according to this example embodiment. FIG. 4B is a schematic side view for explaining a state in which the laminating and shaping apparatus according to this example embodiment is inclined. The difference of the laminating and shaping apparatus according to this example embodiment from the abovementioned second example embodiment is that the apparatus includes an inclination driver. Since the rest of the arrangement and the operation are the same as the second example embodiment, the same reference numerals denote the same parts and the same operations, and a detailed explanation thereof will be omitted.

A laminating and shaping apparatus 400 further includes an inclination driver 401. The inclination driver 401 inclines a base plate 207. For example, the inclination driver 401 inclines the base plate 207 by pivoting the base plate 207 around an axis at the left end of the base plate 207, which extends in a direction perpendicular to the drawing surface of FIG. 4A.

For example, the inclination driver 401 is a device that inclines the base plate 207 (the laminating and shaping apparatus 400) by lifting it from below. Examples of the device are a mechanical jack, a liquid jack, and an air jack, but the device is not limited to them. Since the inclination driver like this is installed on the bottom surface at the right end of the base plate 207, it is possible to lift the right end of the base plate 207 and incline the base plate 207. Note that the method of inclining the laminating and shaping apparatus 400 is not limited to the method of lifting from below by using a jack or the like, and may also be, for example, a method of pulling up from above by using a crane or the like. Note also that the inclination can be fixed.

In this example embodiment, a tank cover 441 (the side wall of a shaping tank) is attached to a tank case 442 so as to be openable. In addition, the tank cover 441 is formed in a direction in which a light beam 222 comes. As shown in FIG. 4B, when the laminating and shaping apparatus 400 is inclined and the tank cover 441 is opened by being flipped up, the light beam 222 can directly be emitted to a shaping material 214. That is, the tank cover 441 is opened when emitting the light beam 222 to the shaping material 214.

When operating the laminating and shaping apparatus 400 in a horizontal state, the tank cover 441 must be closed in order to prevent a fall of the shaping material 214 supplied between the tank cover 441 and a shaping plate 205. That is, the tank cover 441 and the shaping plate 205 must sandwich and press the supplied shaping material 214 in order to prevent collapse of the shaping material 214. When the tank cover 441 is thus closed, the light beam 222 from a light emitter 202 is emitted to the shaping material 214 through the tank cover 441. The light beam 222 to be emitted decays while the light beam 222 passes through the tank cover 441 as described above, and this makes it impossible to give desired heat (energy) to the shaping material 214. Note that in this case, desired heat can be given to the shaping material 214 by increasing the emission time of the light beam 222, but the shaping time increases.

To directly emit the light beam 222 to the shaping material 214, the whole laminating and shaping apparatus 400 is inclined, and the tank cover 441 is opened. That is, while collapse of the supplied shaping material 214 is prevented by inclining the light emitter 202 and the shaping tank 204, the light beam 222 is directly emitted to the shaping material 214 by opening the tank cover 441. In this case, the light beam 222 can directly be emitted to the shaping material 214 because there is no obstacle between the light emitter 202 and the shaping material 214.

Since the laminating and shaping apparatus 400 is inclined, the shaping material 214 supplied between the shaping plate 205 and the tank cover 441 moves from the high side to the low side (from the upper portion of the inclination to the lower portion of the inclination). This makes it possible to uniformize the bulk density of the shaping material 214. Note that the shaping material 214 can be supplied in either a state in which the laminating and shaping apparatus 400 is inclined or a state in which it is not inclined.

Also, a controller 208 can adjust the angle of inclination of the laminating and shaping apparatus 400 by the inclination driver 401 and the emission time of the light beam 222, in accordance with a detection result from a supply amount sensor 213.

According to this example embodiment, by inclining the apparatus and opening the tank cover (side wall), it is possible to directly emit the light beam to the shaping material, and manufacture a laminated and shaped product 210 while laminating the shaping material in the horizontal direction. Also, the supplied shaping material does not fall even when the tank cover is opened, because the apparatus is inclined. In addition, since the apparatus is inclined, the shaping material moves from the upper portion of the inclination to the lower portion of the inclination. As a consequence, the bulk density of the supplied shaping material can be uniformized.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

What is claimed is:

1. A laminating and shaping apparatus comprising:
a shaping tank in which a laminated and shaped product is shaped by an accommodated shaping material;
a slider that has a shaping reference surface as a base of the laminated and shaped product, and slidably moves in a direction away from an inner wall of said shaping tank and perpendicular to the shaping reference surface;
a light emitter that emits a light beam to the shaping material in said shaping tank from outside said shaping tank; and
a material supplier that supplies the shaping material between an inner wall of said shaping tank, which is formed on a side of said light emitter, and the shaping reference surface, by dropping the shaping material,
wherein said light emitter emits the light beam to the shaping material accommodated between the inner wall and the shaping reference surface.

2. The apparatus according to claim 1, wherein the shaping reference surface is one of a surface parallel to a vertical direction and a surface making an angle of not more than 45° to the vertical direction.

3. The apparatus according to claim 1, wherein the inner wall includes a light transmitting portion that transmits the light beam.

4. The apparatus according to claim 1, wherein the inner wall is openable, and is opened when the light beam is emitted to the shaping material.

5. The apparatus according to claim 1, further comprising an inclination driver that inclines the shaping tank.

6. The apparatus according to claim 1, wherein the shaping material includes one of a powder material and a liquid material.

7. The apparatus according to claim 1, further comprising a detector that detects a supply amount of the shaping material supplied by said material supplier.

8. The apparatus according to claim 7, further comprising a controller that controls at least one of said material supplier, said light emitter, said driver, and said inclination driver, in accordance with a detection result obtained by the detector.

9. A method for controlling a laminating and shaping apparatus comprising:
a shaping tank in which a laminated and shaped product is shaped by an accommodated shaping material; and
a slider that has a shaping reference surface as a base of the laminated and shaped product, and slidably moves in a direction away from an inner wall of the shaping tank and perpendicular to the shaping reference surface, the method comprising:
supplying the shaping material between an inner wall of the shaping tank, which is formed on a side of the light emitter, and the shaping reference surface, by dropping the shaping material; and
emitting a light beam to the shaping material in the shaping tank from outside the shaping tank,
wherein in the emitting, the light beam is emitted to the shaping material accommodated between the inner wall and the shaping reference surface.
